(19) United States
(12) Patent Application Publication
(10) Pub. No.: US 2009/0290956 A1
(43) Pub. Date: Nov. 26, 2009

(54) SELF TAPPING NUT

(76) Inventor: To-Ha Loi, Taipei (TW)

Correspondence Address: To-Ha Loi, 235 Chung - Ho Box 8-24, Taipei, 235, TW

(21) Appl. No.: 12/126,937

(22) Filed: May 26, 2008

(51) Int. Cl. F16B 37/14

(52) U.S. Cl. 411/429

(57) ABSTRACT

A self tapping nut includes a round cylindrical cap, and an upper half of the cap is formed with a deformable portion with a thin wall. An upper edge of the deformable portion is formed as a protruding lip and a lower half of the cap is formed with an un-deformable portion. One end of the un-deformable portion of the cap is installed with a drilling head by which in use of the drilling head performing a drilling on a work piece directly and simplifying a process of a work.

### FIELD OF INVENTION

The present invention relates to nuts, and in particular to a self tapping nut with a drilling head on one end thereof by which the self tapping nut can drill a work piece directly so as to simplify a working process.

### DESCRIPTION OF THE PRIOR ART

A prior art of mounting a object to a work piece (such as a fabrication) is performed by tapping a work piece or welding a fix nut or screw on a work piece, but it is inconvenient and also a waste of time and energy.

To improve above-mentioned prior art, a nut has been designed, which includes two different kinds: one is a threaded holed nut and the other is a stud form nut. The former has a threaded hole in a nut for receiving a bolt; and the latter has a stud which is combined to the nut. However, either the threaded holed nut or the stud from nut provides convenience operation than that of the prior art because of no welding process being performed, but it still needs a driller to drill a penetrating hole for positioning the nut and for making further process for retaining the nut. Thus, there is a demand for the improvement of the nuts.

For an embodiment of a prior screw type nut illustrated in FIGS. 1 to 5, the nut includes a round cylindrical cap 10 and a threaded rod 20 which is combined to the cap 10, wherein as illustrated in FIG. 2, an upper half of the cap 10 is formed with a deformable portion 10A with a thin wall. An upper edge of the deformable portion 10A is formed as a protruding lip 11 and a lower half of the cap 10 is formed an un-deformable portion 10B for receiving and fixing the threaded rod 20 (an un-deformable portion 10B with a thread on the inner wall of a nut).

By above mentioned structure, a prior nut needs a driller 30 to drill a penetrating hole 41 on a work piece 40 (referring to FIG. 3), thus put the nut into the penetrating hole 41 (referring to FIG. 4) and use a pneumatic (or electromotive) nut driving tool 50 pulling the deformable portion 10A of the cap 10 so that the deformable portion 10A will expand and deform as a protrusion ring 12 (referring to FIG. 5). With the protruding lip 11 at an upper edge of the deformable portion 10A, the cap 10 can be clamped and fixed to an edge of a penetrating hole 41 so as to fix the nut to the work piece 40.

Therefore, either a prior nut or a prior screw type nut needs a driller 30 to drill a penetrating hole for positioning the nut and the further process is need. Thus there is an demand for a novel design which can improve the prior art defects.

### SUMMARY OF THE PRESENT INVENTION

Accordingly, the primary object of the present invention is to correct the disadvantage of the prior nut and to provide a self tapping nut with a drilling head on one end thereof and by use of the drilling head to drill on a work piece to simplify the process of a work.

To achieve above object, the present invention provides a self tapping nut including a round cylindrical cap, and an upper half of the cap is formed with a deformable portion with a thin wall. An upper edge of the deformable portion is formed as a protruding lip and a lower half of the cap is formed an un-deformable portion with a thick wall. The feature of the self tapping nut is: One end of the un-deformable portion of the cap is installed with a drilling head; therefore, by use of the drilling head performing drilling on a work piece, a convenient self tapping nut is provided for simplifying a working process.

The various objects and advantages of the present invention will be more readily understood from the following detailed description when read in conjunction with the appended drawing.

### BRIEF DESCRIPTION OF THE DRAWINGS

FIG. 1 is a perspective view of a prior screw type nut.

FIG. 2 is a cross section view of a prior screw type nut.

FIG. 3 is a schematic view of a driller which drills a penetrating hole in advance while using a prior screw type nut.

FIG. 4 is a schematic view showing that a prior screw type nut is placed in a penetrating hole.

FIG. 5 is a schematic view showing an electromotive (or pneumatic) nut driving tool pulling the deformable portion of a prior screw type nut so that the deformable portion will expand and deform as a protrusion ring.

FIG. 6 is a perspective view about an embodiment of a screw type self tapping nut of the present invention.

FIG. 7 is a cross section view about an embodiment of a screw type self tapping nut of the present invention.

FIG. 8 is a schematic view showing a work piece being drilled by a drilling head formed in one end of the screw type self tapping nut of the present invention.

FIG. 9 is a schematic view showing that an electromotive (or pneumatic) nut driving tool pulls the deformable portion of the screw type self tapping nut of the present invention so that the deformable portion will expand and deform as a protrusion ring.

FIG. 10 is a cross section view of an embodiment about a self tapping nut of the present invention.

FIG. 11 is a schematic view showing an electromotive (or pneumatic) nut driving tool pulling the deformable portion of the self tapping nut of the present invention so that the deformable portion will expand and deform as a protrusion ring.

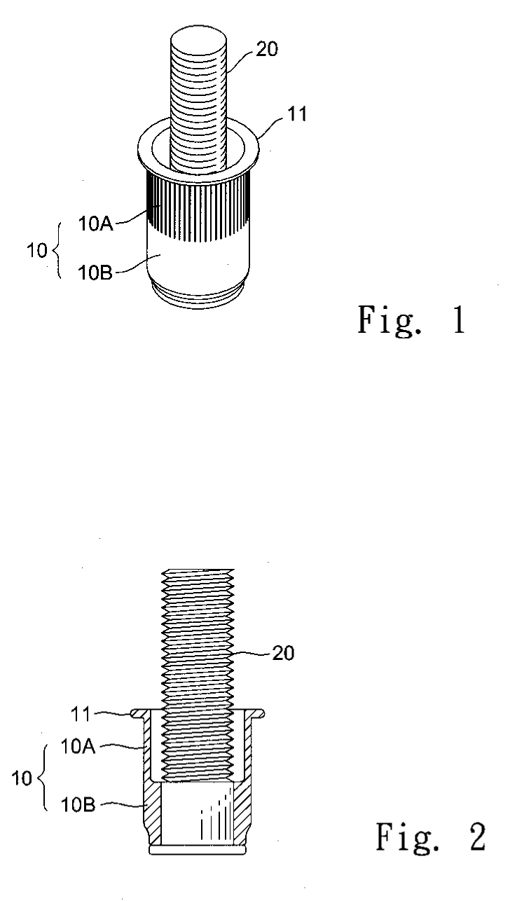

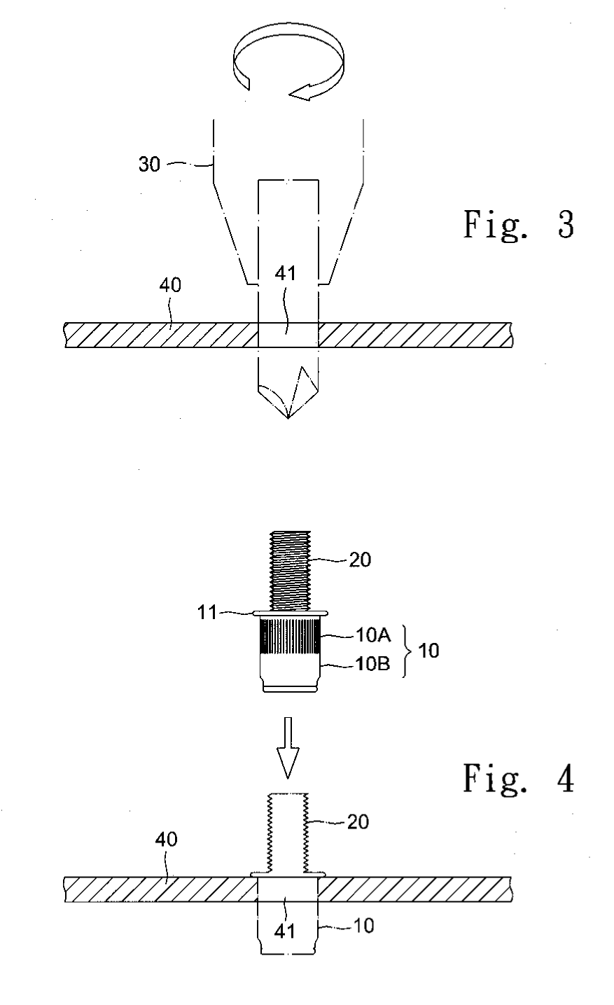

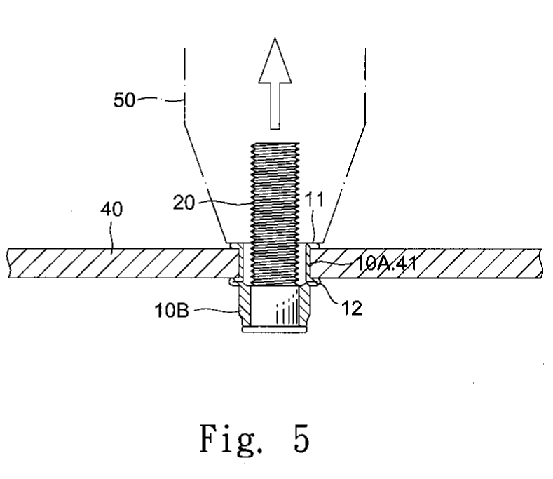

### DETAILED DESCRIPTION OF THE PREFERRED EMBODIMENTS

Now, the present invention will be described more specifically with reference to the following embodiments. It is to be noted that the following descriptions of preferred embodiments of this invention are presented herein for purpose of illustration and description only; it is not intended to be exhaustive or to be limited to the precise form disclosed.

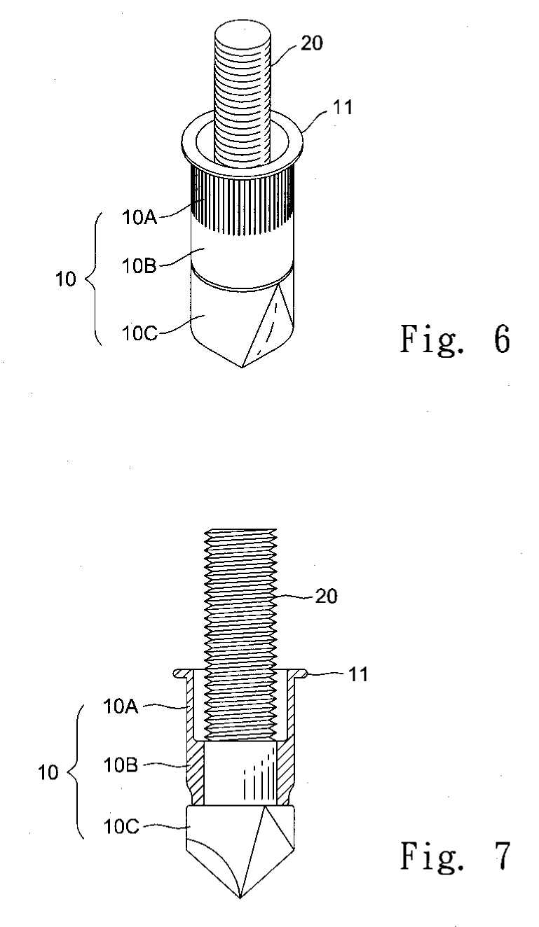

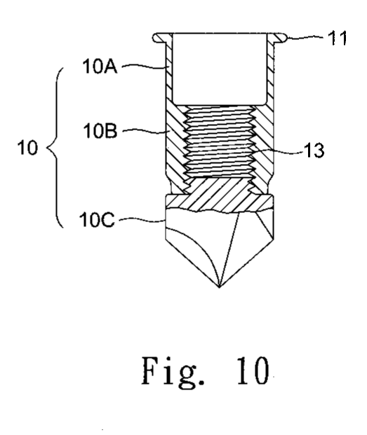

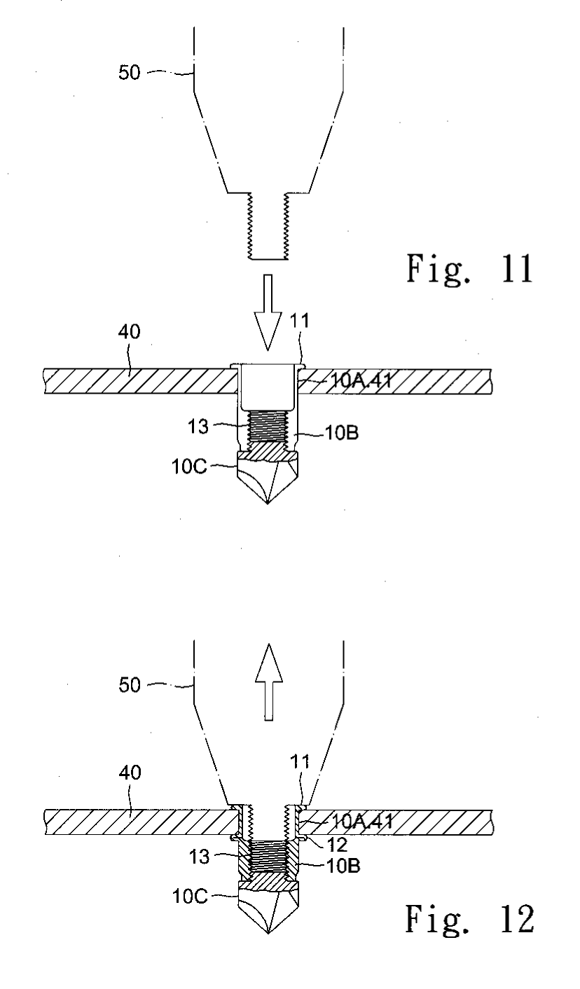

The technique and mechanism to achieve the purpose of the present invention will be illustrated in FIGS. 6 to 9 for the embodiment of a screw type selftapping nut and be illustrated in FIGS. 10 and 11 of the embodiment of a self tapping nut.

With referring to FIGS. 6 and 7, the screw type selftapping nut of the present invention is illustrated. The nut includes a round cylindrical cap 10 and a threaded rod 20 which is combined to the cap 10. An upper half of the cap 10 is formed with a deformable portion 10A with a thin wall. An upper edge of the deformable portion 10A is formed as a protruding lip 11 and a lower half of the cap 10 is formed with an un-deformable portion 10B for receiving and fixing the threaded rod 20.

However, above mentioned structure is known in the prior art and is not the main concern in the present invention. Therefore, the detail will not further described herein. The features of the present invention will be described hereinafter.

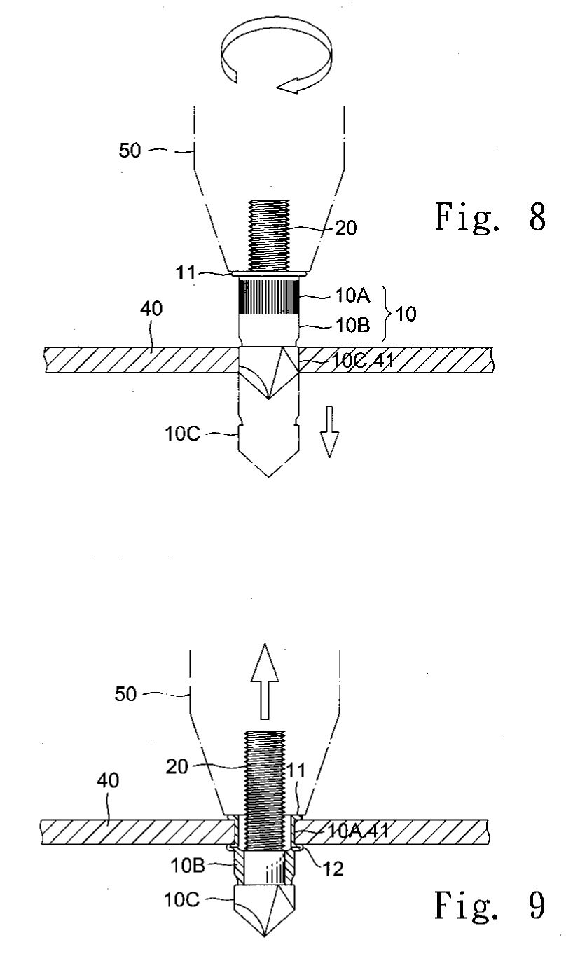

One end of the un-deformable portion 10B of the cap 10 is installed with a drilling head 10C by which in use of the drilling head, a pneumatic (or electromotive) nut driving tool 50 will clamp the threaded rod 20 and then drill a work piece 40 (referring to FIG. 8). Then the pneumatic (or electromotive) nut driving tool 50 will pull the deformable portion 10A of the cap 10 so that the deformable portion 10A will expand and deform as a protrusion ring 12 (referring to FIG. 9). With the protruding lip 10 at an upper edge of the deformable portion 10A, the cap 10 can be clamped and fixed to an edge of a penetrating hole 41 so as to fix the screw type self tapping nut to the work piece 40.

Referring to FIGS. 10 and 11, in the embodiment of the self tapping nut, the nut has a round cylindrical cap 10, and an upper half of the cap 10 is formed with a deformable portion 10A with a thin wall. An upper edge of the deformable portion 10A is formed as a protruding lip 11 and a lower half of the cap 10 is formed an un-deformable portion 10B with a thick wall and a thread on the inner wall.

However above mentioned structure is known in the prior art and is not the main concern in the present invention. Therefore, the detail will not further described herein. The features of the present invention will be described hereinafter.

One end of the un-deformable portion 10B of the cap 10 is installed with a drilling head 10C by which in use of the cap, a pneumatic (or electromotive) nut driving tool 50 will clamp the nut and then drill a work piece 40. Then the pneumatic (or electromotive) nut driving tool 50 will pull the deformable portion 10A of the cap 10 so that the deformable portion 10A will expand and deform as a protrusion ring 12 (referring to FIG. 11). With the protruding lip 10 at an upper edge of the deformable portion 10A, the cap 10 can be clamped and fixed to an edge of a penetrating hole 41 so as to fix the nut to the work piece 40.

Therefore, by either the embodiment of the screw type self tapping nut illustrated in FIGS. 6 to 9 or the embodiment of the self tapping nut illustrated in FIGS. 10 to 11, the present invention includes a round cylindrical cap 10, and an upper half of the cap 10 is formed with a deformable portion 10A with a thin wall. An upper edge of the deformable portion 10A is formed as a protruding lip 11 and a lower half of the cap 10 is formed with an un-deformable portion 10B with a thick wall. One end of the un-deformable portion 10B of the cap 10 is installed with a drilling head 10C. By using of the drilling head 10C, a drilling work can be directly performed on a work piece 40 and the process of a work is simplified.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A self tapping nut comprising: a round cylindrical cap; an upper half of the cap formed with a deformable portion with a thin wall; an upper edge of the deformable portion formed as a protruding lip and a lower half of the cap formed an un-deformable portion with a thick wall;
a special drilling head formed in an end of the un-deformable portion of the nut; by using of the drilling head performing drilling operation on a work piece so as to provide a convenient self tapping nut which simplify a work process.

2. The self tapping nut as claimed in claim 1, wherein a threaded rod is combined to a top of the cap.
